(19) United States
(12) Patent Application Publication
(10) Pub. No.: US 2018/0319113 A1
(43) Pub. Date: Nov. 8, 2018

(54) METHOD OF MANUFACTURING ALL-WATER FOAMED SHOE SOLE AND ALL-WATER FOAMED SHOE SOLE MANUFACTURED BY THE SAME

(71) Applicant: CHI-KUNG WU, TAICHUNG CITY (TW)

(72) Inventor: CHI-KUNG WU, TAICHUNG CITY (TW)

(21) Appl. No.: 15/586,663

(22) Filed: May 4, 2017

(51) Int. Cl. B29D 35/00; C08G 18/42; C08G 18/76; A43B 13/04; A43B 13/18

(52) U.S. Cl. CPC B29D 35/0009; C08G 18/42; C08G 2101/0083; A43B 13/04; A43B 13/187; C08G 18/7671

(57) ABSTRACT

The method of manufacturing all-water foamed shoe sole includes the following steps. Prepare main agent and solidifying agent: prepare a main agent and a solidifying agent. The main agent is a mixture of polytetrahydrofuran (PTMEG), an all-water foaming agent, and a catalyst. The solidifying agent is prepolymerized by polyester polyol and methylene diphenyl diisocyanate (MDI). Injection and foaming: the main agent and the solidifying agent are injected into a mold by an injector in a weight ratio of 100:50-60 to be foamed and shaped into a shoe sole. Removing mold: take the shoe sole out from the mold wherein the shoe sole has a specific gravity ranged from 0.2 g/cc to 0.28 g/cc.

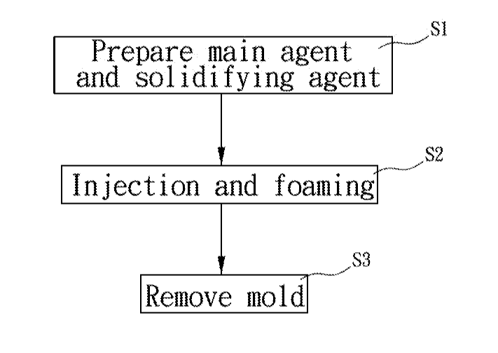

### BACKGROUND OF THE INVENTION

### Field of the Invention

The present invention relates to a pipe clamp pliers.

### Description of the Prior Art

A shoe sole plays an important role in shoes, especially for cushion and comfort. The performance of cushion and comfort is provided by the material characteristics of the shoe sole. Besides, the weight of the shoe sole is decided by the specific gravity thereof. That is, a heavy shoe sole, even if having good performance of cushion, is still a burden for the user. Thus, the performance and feeling of walking or exercising is affected.

Conventional shoe soles are usually made of foamed plastic material, such as TPU or EVA. However, shoe soles having desired physical characteristics usually have a density larger than 0.32 g/cc and compression ratio higher than 15%. That is, the conventional shoe soles are not light enough.

### SUMMARY OF THE INVENTION

The main object of the present invention is to provide an all-water foamed shoe sole which is lighter but still advantageous at physical characteristics.

To achieve the above and other objects, the method of manufacturing all-water foamed shoe sole includes the following steps:

Prepare main agent and solidifying agent: prepare a main agent and a solidifying agent. The main agent is a mixture of polytetrahydrofuran (PTMEG), an all-water foaming agent, and a catalyst. The solidifying agent is prepolymerized by polyester polyol and methylene diphenyl diisocyanate (MDI).

Injection and foaming: the main agent and the solidifying agent are injected into a mold by an injector in a weight ratio of 100:50-60 to be foamed and shaped into a shoe sole.

Remove mold: take the shoe sole out from the mold. The shoe sole has a specific gravity ranged from 0.2 g/cc to 0.28 g/cc.

Thereby, an all-water foamed shoe sole which is lighter and has excellent physical characteristics is provided.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

The FIGURE is a flow chart of the present invention.

### DETAILED DESCRIPTION OF THE PREFERRED EMBODIMENTS

Please refer to the FIGURE, the method of manufacturing all-water foamed shoe sole includes the following steps.

Prepare main agent and solidifying agent 51: preparing a main agent and a solidifying agent wherein the main agent is a mixture of polytetrahydrofuran (PTMEG), an all-water foaming agent, and a catalyst, and the solidifying agent is prepolymerized by polyester polyol and methylene diphenyl diisocyanate (MDI). Specifically, the main agent is composed of 95-98% of polytetrahydrofuran by weight, 2-3% of the all-water foaming agent by weight, and 0.2-1% of the catalyst by weight. Preferably, the main agent is composed of 96.9% of polytetrahydrofuran by weight, 2.5% of the all-water foaming agent by weight, and 0.6% of the catalyst by weight. Besides, the solidifying agent is composed of 20-40% of polyester polyol by weight and 60-80% of methylene diphenyl diisocyanate by weight. Preferably, the solidifying agent is composed of 30% of polyester polyol by weight and 70% of methylene diphenyl diisocyanate by weight. On the other hand, the polyester polyol in the solidifying agent is selected from a group composed of adipic acid based polyester polyol and polycaprolactone, and an average molecular weight of the polyester polyol is about 2000.

Injection and foaming S2: the main agent and the solidifying agent are injected into a mold by an injector (mixing at high speed) in a weight ratio of 100:50-60 to be foamed and shaped into a shoe sole (by a heater or others).

Remove mold S3: take the shoe sole out from the mold wherein the shoe sole has a specific gravity ranged from 0.2 g/cc to 0.28 g/cc. Preferably, the specific gravity of the shoe sole is ranged from 0.22 g/cc to 0.25 g/cc.

Result of tests of conventional PU foamed shoe sole and the all-water foamed shoe sole of the present invention is shown below.

First, the following table shows the result of tests of conventional PU foamed shoe sole.

The following table shows the result of tests of the water foamed shoe sole of the present invention. The hydrolyzation is tested at 80 degrees Celsius and the humidity of 95%.

In view of the result of tests listed above, the shoe sole of the present invention has a smaller specific gravity than conventional PU shoe soles so that the shoe sole of the present invention is lighter. In addition, the compression set of the shoe sole of the present invention is lower than 10. Thus, the shoe sole is prevented from deformation after being stepped on for a long time, and the performance of cushion is excellent. Besides, other physical characteristics of the present invention are not inferior to those of the conventional PU shoe soles.

What is claimed is:

1. A method of manufacturing all-water foamed shoe sole, including steps of:
preparing main agent and solidifying agent: preparing a main agent and a solidifying agent, the main agent being a mixture of polytetrahydrofuran (PTMEG), an all-water foaming agent, and a catalyst, the solidifying agent being prepolymerized by polyester polyol and methylene diphenyl diisocyanate (MDI);
injection and foaming: the main agent and the solidifying agent being injected into a mold by an injector in a weight ratio of 100:50-60 to be foamed and shaped into a shoe sole;
removing mold: taking the shoe sole out from the mold wherein the shoe sole has a specific gravity ranged from 0.2 g/cc to 0.28 g/cc.

2. The method of manufacturing all-water foamed shoe sole of claim 1, wherein the main agent is composed of 95-98% of polytetrahydrofuran by weight, 2-3% of the all-water foaming agent by weight, and 0.2-1% of the catalyst by weight.

3. The method of manufacturing all-water foamed shoe sole of claim 2, wherein the main agent is composed of 96.9% of polytetrahydrofuran by weight, 2.5% of the all-water foaming agent by weight, and 0.6% of the catalyst by weight.

4. The method of manufacturing all-water foamed shoe sole of claim 1, wherein the solidifying agent is composed of 20-40% of polyester polyol by weight and 60-80% of methylene diphenyl diisocyanate by weight.

5. The method of manufacturing all-water foamed shoe sole of claim 4, wherein the solidifying agent is composed of 30% of polyester polyol by weight and 70% of methylene diphenyl diisocyanate by weight.

6. The method of manufacturing all-water foamed shoe sole of claim 1, wherein the polyester polyol in the solidifying agent is selected from a group composed of adipic acid based polyester polyol and polycaprolactone.

7. The method of manufacturing all-water foamed shoe sole of claim 1, wherein an average molecular weight of the polyester polyol is about 2000.

8. The method of manufacturing all-water foamed shoe sole of claim 1, the specific gravity of the shoe sole is ranged from 0.22 g/cc to 0.25 g/cc.

9. An all-water foamed shoe sole, being made by the method of manufacturing all-water foamed shoe sole of claim 1.
